(19) United States
(12) Patent Application Publication
(10) Pub. No.: US 2006/0169342 A1
(43) Pub. Date: Aug. 3, 2006

(54) Preformed styrofoam utility pipe/conduit weight credit support unit

(76) Inventor: Victor Kazys Sestokas, Warren, NJ (US)

Correspondence Address: Victor K. Sestokas, PE, 18 Round Top Road, Warren, NJ, 07059, US

(21) Appl. No.: 10/644,986

(22) Filed: Aug. 21, 2003

(51) Int. Cl. F16L 55/00; F16L 3/00; F16L 57/00; F16L 11/00

(52) U.S. Cl. 138/103; 138/106; 138/110

(57) ABSTRACT

The device and method for construction of linear utility pipe/conduit in adverse soil conditions where instability, low bearing capacity or high water table challenges are overcome by the use of linear Styrofoam “weight-credit” cradles. It provides a marked improvement over standard methods of utility pipe/conduit installation in unstable foundation materials. The cradles can also be simply used as a cushion to protect the utility installation against point loads that could be inflicted as a result of unfavorable foundation conditions. The device is manufactured from Styrofoam material suitable for subterrainian and subaqueous installations. Cross-sectional dimensions can be adjusted according to the specific application depending on the physical properties of the pipe/conduit and the soil parameters where the system is to be installed. In essence the cradle is manufactured as a pre-formed unit extending usually to the spring-line of the pipe/conduit to facilitate acceptance of the pipe/conduit and to provide a stable platform and support for the full length of the pipe/conduit section. The cradles are generally installed in the trenches first, then the pipe/conduit section is placed into the cradle and joined to the adjacent pipe/conduit section. The width and thickness of the cradle is a function functionally determined as part an engineering design of the pipe/conduit system.

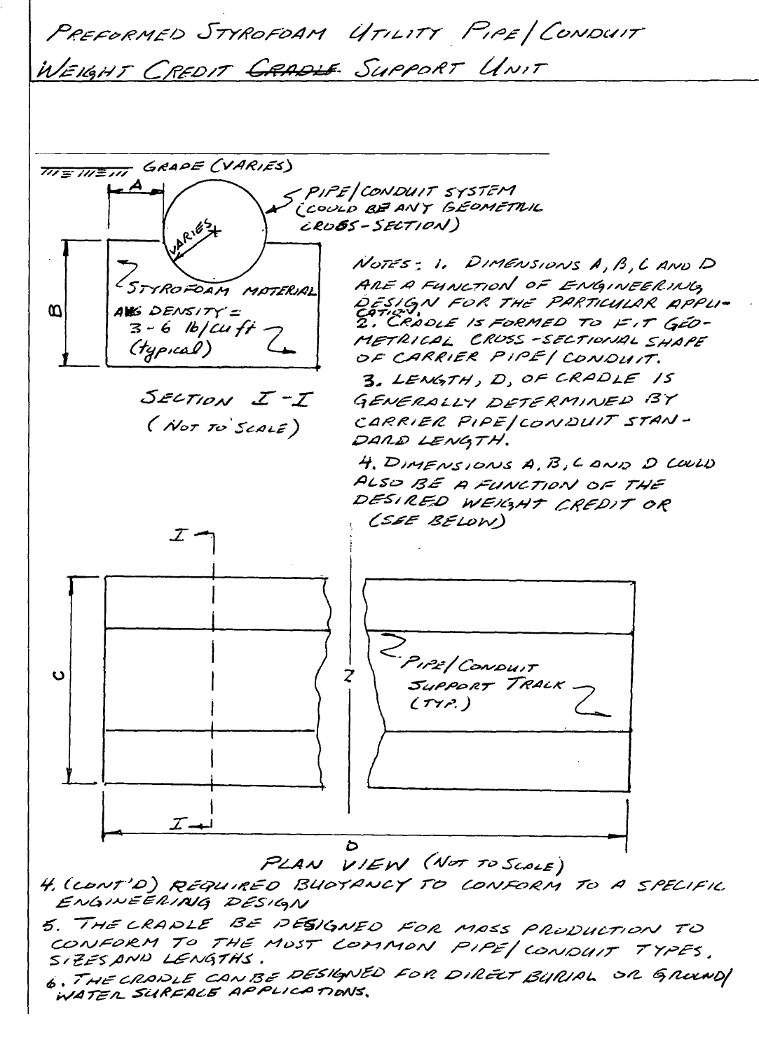

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF INVENTION

The invention is related to the soil mechanics, foundation engineering, utility pipe/conduit system designs and construction thereof. Specifically the invention allows the facilitation of utility pipe/conduit installation under conditions where the character and bearing conditions of the soil and/or foundation materials are not conducive for standard types of installations; or where the use of the invention allows for substantial savings in installation costs where the character and bearing conditions of the soil/foundation materials in lieu of standard more expensive types of construction methods. The invention replaces the use of typical reinforced concrete cradles supported by piles or caissons or open cut installations requiring cofferdams, sheeting and dewatering. The invention when properly designed could even “float” a utility line on open waters with proper anchorage/mooring.

The invention can also be used simply as a foundation cushion for the utility pipe/conduit system to protect the asset from potential damage in installations where the site foundation material is craggy, rocky, boulder or cobble strewn, or simply anywhere uneven protrusions occur in the foundation material that may inflict damaging point loads on the utility pipe/conduit system.

Table 005 indicates a summary of improvements over standard installation methods that the invention provides.

A sample computation of Styrofoam weight credit analysis is attached in order to demonstrate the mathematical and physical theories governing the phenomena of the invention. A 12-inch diameter ductile iron pipe is illustrated in a trench cross section bedded, for the sake of simplicity, on a rectangular Styrofoam section 24-inches thick. The water table is at ground surface for the submerged computation with accompanied stress distribution diagram, and at the base of the Styrofoam bedding in the “dry” state. In both cases there are no appreciable stress increases on the underlying organic silt—therefore, no net settlement due to the additional load resulting form the utility/pipe conduit installation. The computations are attached as page 8 of this document.

TABLE 005

| | | New Method and |
|---|---|---|
| Application | Old Method | Benefits/Improvements |
| Installation of utility pipe/conduit | Preconsolodation by | Construct utility pipe/conduit |
| in unstable soils, eg, peat, organic | surcharging the sensitive | system using the Styrofoam |
| clays or silts, etc. | stratum with placement of | cradles using open cut |
| | temporary overburden loads. | methods. |
| | OR | Benefit: cost and time savings |
| | Construct reinforced concrete | due to comparative ease of |
| | cradles supported on pile or | construction. |
| | caisson foundation. | Utilize the lighter density |
| Eliminate additional net load on | Excavate overburden to point | Styrofoam cradle to obtain the |
| sensitive soil stratum due to | of zero net loading. | weight credit required. |
| weight of utility pipe/conduit | | Benefit: cost and time savings |
| loading. | | due to comparative ease of |
| | | construction. |
| High water table or open water | Strap to piles or caissons | Low density of Styrofoam |
| utility pipe/conduit installation. | firmly anchored into suitable | cradle allows for “floatation” |
| | foundation material. | of utility pipe/conduit system |
| | | in high water table situations |
| | | or on open waters. |
| | | Benefit: Need for expensive |
| | | foundation eliminated, |
| | | resulting in cost and time |
| | | savings. |
| Rough bedding conditions where | Excavate additional depth, | Use of cradle provides |
| point loading can damage utility | backfill with acceptable | cushion for underside of |
| pipe/conduit system. | bedding material such as | utility pipe/conduit system. |
| | sand, gravel, crushed stone, | Benefit: Savings in cost and |
| | etc. | time by eliminating the need |
| | | for extra depth excavation and |
| | | soil bedding. |

### BRIEF SUMMARY OF THE INVENTION

The invention allows for the facilitation of pipe/utility installation under conditions where the character and bearing capacity of the soil and foundation materials are not conducive for standard types of installation. The Styrofoam cradle upon which the utility pipe/conduit is bedded provides a weight credit displacement over the in situ soil/foundation material allowing additional loading capacity. The object of the invention is to provided a cost savings advantage over standard methods for the construction of utility pipe/conduit systems in unstable foundation materials.

### BRIEF DESCRIPTION OF THE SEVERAL VIEWS OF THE DRAWING

The 8.5″×11″ ink drawing on white paper entitled “Preformed Styrofoam Utility Pipe/Conduit Weight Credit Support Unit” dated 5^{th} Nov. 2002 indicates a plan view of a typical unit with a Section I-I cut showing a circular pipe supported by the low density Styrofoam unit.

### DETAILED DESCRIPTION OF THE INVENTION

The invention, a cradle composed of preformed Styrofoam, provides a weight credit benefit in utility pipe/conduit installations in unstable soil conditions by displacing the in situ material with the lightweight Styrofoam when the units are utilized.

The Styrofoam cradle device can be mass produced by qualified Styrofoam products manufacturers by molding, extrusion, or other means or processes in standard lengths and cross sections. The units shall be sized to fit most common utility pipe/conduit systems in current use; or the units could even be custom manufactured for specific applications in order to meet the desired dimensions of an engineering design. A suitable Styrofoam material that can be considered for this application is an ASTM C 578, Type IV foam with a compressive strength of 25 pounds per square inch and a density of approximately 1.5 pounds per cubic foot. Dow Chemical Corporation is one of the leading manufacturers of Styrofoam. There are other types of Styrofoam that could be considered for this application.

1. The Styrofoam utility pipe/conduit cradle device provides for continuous and uniform support for linear pipe/conduit installations where the in situ soil conditions are such that the net additional gravity load form the pipe/conduit could cause settlement, differential or otherwise, resulting in vertical discontinuity of the utility pipe/conduit system which can cause breakage, open joints, or other deformation.

2. The extreme light density of the Styrofoam cradle when installed below the ground surface provides for a “weight-credit” simply by volumetric substitution of the displaced more dense native soil with the light weight Styrofoam; thus with a proper engineering design, diminishing in all or to some degree, the additional gravity load and surcharge imposed on the subsurface soil material by the overlying utility pipe/conduit system. The end result is significant reduction or even total elimination of potential settlement/subsidence of the utility pipe/conduit system installation.

3. The natural buoyancy of the light-weight Styrofoam material allows for additional support of utility pipe/conduit systems in high water table soil conditions or even in open waters much like a raft; thus eliminating the need for complex and expensive pilings, caissons or other conventional foundations/method-of-support. The utility piping/conduit systems with proper engineering design can be fully and uniformly supported in the Styrofoam cradle in the high water table conditions of marshes, swamps, wetlands, etc., anywhere the submerged soil conditions are of unfavorable bearing capacity.
